(19) United States
(12) Patent Application Publication
(10) Pub. No.: US 2011/0279622 A1
(43) Pub. Date: Nov. 17, 2011

(54) OPTICAL SCANNING DEVICE, IMAGE FORMING APPARATUS USING THE OPTICAL SCANNING DEVICE, METHOD FOR CONTROLLING THE OPTICAL SCANNING DEVICE, AND PROGRAM PRODUCT FOR EXECUTING THE METHOD

(76) Inventor: Toshio OHIDE, Kanagawa (JP)

(21) Appl. No.: 13/086,719

(22) Filed: Apr. 14, 2011

(30) Foreign Application Priority Data
May 17, 2010 (JP) 2010-112863

(51) Int. Cl. B41J 2/385; G01J 1/20

(52) U.S. Cl. 347/118; 250/201.1

(57) ABSTRACT

The optical scanning device performs a first control operation that when the scanning speed of a deflector is stabilized, a light source is turned on, and when a detection signal is received from a photodetector, the light source is turned off while starting counting the scanning period in the main scanning direction from zero; a second control operation that when the count reaches a first value, the light source is turned on, and when a detection signal is received, the light source is turned off while starting counting the scanning period; and a third control operation that when the count reaches a second value, the light source is turned on, and when a detection signal is received, the light source is turned off while starting counting the scanning period, followed by repetition of the third control until scanning is completed.

### BACKGROUND OF THE INVENTION

1. Field of the Invention

The present invention relates to an optical scanning device to scan an object with a light beam while deflecting the light beam, and to an image forming apparatus to form an image on an image bearing member using the optical scanning device. In addition, the present invention also relates to a method for controlling the optical scanning device, and computer readable program product for executing the method.

2. Description of the Related Art

Electrophotographic digital image forming apparatuses typically include an image bearing member and image forming deices such as a charging device, an optical scanning device, a developing device, a transferring device and a fixing device, and form visible images as follows.
(1) The charging device charges a surface of the image bearing member;
(2) The optical scanning device scans the charged surface of the image bearing member with a light beam, which is emitted by a light source and which is modulated by image data, to form an electrostatic latent image thereon;
(3) The developing device develops the electrostatic latent image with a developer including a toner to form a toner image on the image bearing member;
(4) The transferring device transfers the toner image onto a recording material directly or via an intermediate transfer medium; and
(5) The fixing device fixes the toner image on the recording material, resulting in formation of a visible image on the recording material.

The above-mentioned optical image writing operation (2) of such an optical scanning device typically is as follows. Specifically, a light beam emitted by a light source (such as laser diodes (LDs)) is periodically deflected by a light deflector such as a rotating polygon mirror to scan a surface of a charged photoreceptor in a main scanning direction, which serves as an image bearing member and which is rotated in a sub-scanning direction perpendicular to the main scanning direction, resulting in optical image writing on the surface of the photoreceptor.

In attempting to reduce variation in position (misalignment) of optical scanning lines in the sub-scanning direction, JP2009-175165A proposes an optical scanning device including a photodetector having a first photoreceiver which has a rectangular form and whose two opposed sides through which a light beam passes are perpendicular to the main scanning direction of the light beam and a second photoreceiver which has a parallelogram form and whose two opposed sides through which a light beam passes are slanted relative to the main scanning direction. By determining the time difference between a time when a light beam passes the first photoreceiver and a time when the light beam passes the second photoreceiver, the position of the light beam in the sub-scanning direction is determined, resulting in determination of position (misalignment) of the scanning line of the light beam in the sub-scanning direction. The position of the light beam is corrected based on the thus determined position.

In the optical scanning device, after the scanning speed of the light deflector is stabilized, the light source is turned on to start the scanning operation. In this regard, the time when the light source is turned on is not synchronized with the position of the light deflector in the main scanning direction. Therefore, there is a case where the first signal output from the photodetector is a detection signal for a light beam entering the first photoreceiver or a case where the first signal output from the photodetector is a detection signal for a light beam entering the second photoreceiver.

In this regard, it is necessary to use, as a scan start reference signal, a detection signal for a light beam entering the first photoreceiver because the signal is not influenced by the position of the light beam in the sub-scanning direction. Therefore, it is necessary to recognize a detection signal for a light beam entering the first photoreceiver.

For these reasons, the present inventors recognized that there is a need for an optical scanning device in which a detection signal for a light beam entering the first photoreceiver can be recognized.

### SUMMARY

This patent specification describes a novel optical scanning device, one embodiment of which includes alight source to emit a light beam; a scanner to deflect the light beam using a light deflector and to periodically scan, in a main scanning direction, a scan surface of an object moving in a sub-scanning direction with the deflected light beam; and a photodetector which receives the scanned light beam at a position outside the scan surface of the object and outputs a detection signal and which includes a first photoreceiver which has a rectangular form and whose two opposed sides through which the light beam passes are perpendicular to the main scanning direction of the light beam and a second photoreceiver which has a parallelogram form and whose two opposed sides through which the light beam passes are slanted relative to the main scanning direction. The detection signal output from the photodetector is used as a reference signal for the scanning of the scanner in the main scanning direction.

The optical scanning device further includes a controller. The controller performs a first control operation in which when the scanning speed of the scanner (light deflector) is stabilized, the light source is turned on, and when a detection signal from the photodetector is detected, the light source is turned off while starting counting of the scanning period of the scanner in the main scanning direction from zero; a second control operation in which when the count in the scanning period counting performed in the first control operation reaches a predetermined first value, the light source is turned on, and when a detection signal from the photodetector is detected, the light source is turned off while starting counting of the scanning period of the scanner in the main scanning direction from zero; and a third control operation in which when the count in the scanning period counting performed in the second control operation reaches a predetermined second value, the light source is turned on, and when a detection signal from the photodetector is detected, the light source is turned of f while starting counting of the scanning period of the scanner in the main scanning direction from zero. The controller repeats the third control operation until scanning of the object is completed.

This patent specification describes a novel image forming apparatus, one embodiment of which includes an image bearing member, a charger to charge a surface of the image bearing member, and the above-mentioned optical scanning device to scan the charged surface of the image bearing member with a light beam while turning on and of f the light source based on image data to form an electrostatic latent image on the image bearing member.

This patent specification describes a novel method for controlling an optical scanning device. The optical scanning device includes a light source to emit a light beam; a scanner to deflect the light beam using a light deflector and to periodically scan, in a main scanning direction, a scan surface of an object moving in a sub-scanning direction with the deflected light beam; and a photodetector which receives the scanned light beam at a position outside the scan surface of the object and which includes a first photoreceiver which has a rectangular form and whose two opposed sides through which the light beam passes are perpendicular to the main scanning direction of the light beam and a second photoreceiver which has a parallelogram form and whose two opposed sides through which the light beam passes are slanted relative to the main scanning direction, wherein the detection signal output from the photodetector is used as a reference signal for the scanning of the scanner in the main scanning direction.

The method includes first, second and third control steps. The first control step includes turning on the light source when the scanning speed of the scanner (light deflector) is stabilized; and then turning off the light source while starting counting of the scanning period of the scanner in the main scanning direction from zero when a detection signal from the photodetector is detected. The second control step includes turning on the light source when the count in the scanning period counting performed in the first control step reaches a predetermined first value; and then turning of f the light source while starting counting of the scanning period of the scanner in the main scanning direction from zero when a detection signal from the photodetector is detected. The third control step includes turning on the light source when the count in the scanning period counting performed in the second control step reaches a predetermined second value; and then turning off the light source while starting counting of the scanning period of the scanner in the main scanning direction from zero when a detection signal from the photodetector is detected. The third control step is repeated until scanning of the object is completed.

This patent specification describes a novel computer program product stored on a computer readable storage medium for carrying out the above-mentioned method for controlling the optical scanning device.

### BRIEF DESCRIPTION OF THE DRAWINGS

A more complete appreciation of aspects of the invention and many of the attendant advantage thereof will be readily obtained as the same become better understood by reference to the following detailed description when considered in connection with the accompanying drawings, wherein:

FIG. 1 is a schematic view illustrating an image forming section of an example of the image forming apparatus of the present invention including an example of the optical scanning device of the present invention;

FIG. 2 is a schematic view illustrating the photodetector of the optical scanning device illustrated in FIG. 1;

FIGS. 3(a) and 3(b) are timing charts illustrating two cases of the controlling operation of a controller of the optical scanning device illustrated in FIG. 1; and

FIG. 4 is a timing chart illustrating another case of the controlling operation of the controller of the optical scanning device illustrated in FIG. 1.

### DESCRIPTION OF THE PREFERRED EMBODIMENTS

The present invention will be described by reference to drawings.

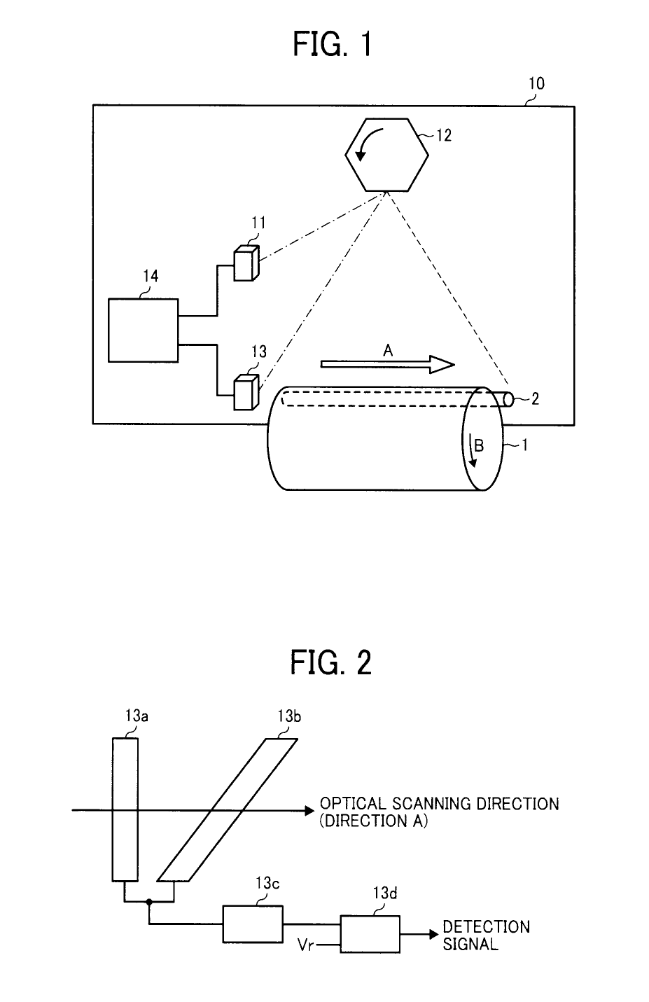

Initially, the configuration and operation of the image forming section of an example of the image forming apparatus of the present invention will be described by reference to FIG. 1. This example of the image forming apparatus includes, as an image writing device, an example of the optical scanning device of the present invention, which emits one light beam and deflects the light beam to scan one image bearing member (photoreceptor) with the light beam. However, the numbers of the light beam and the image bearing member are not limited thereto, and plural light beams and plural image bearing members can be used for the image forming apparatus.

FIG. 1 is a schematic view illustrating an image forming section of an example of the image forming apparatus of the present invention including an example of the optical scanning device of the present invention. FIG. 2 is a schematic view illustrating the photodetector of the optical scanning device illustrated in FIG. 1.

The image forming apparatus is an electrophotographic image forming apparatus for use as a digital copier, a digital multifunctional image forming apparatus, a facsimile, and a printer, and includes an optical scanning device 10, which is an example of the optical scanning device of the present invention.

Referring to FIG. 1, the optical scanning device 10 includes alight source 11 having a light emitting element such as a laser diode (LD); a light deflector 12 (polygon mirror in this example) to deflect/scan a light beam (such as a laser beam) emitted by the light source; an optics system (not shown) to focus the deflected light beam on a scan surface of a drum-shaped image bearing member 1 (hereinafter referred to as a photoreceptor drum or a photoreceptor), which is rotated in a sub-scanning direction B and which is previously charged by a charger 2, resulting in formation of an electrostatic latent image on the scan surface of the image bearing member; a photodetector 13 to detect the deflected light beam while outputting a detection signal; and a controller 14 to control the operations of the optical scanning device by using the detection signal as a reference signal. The light deflector and the optics system serve as a scanner. In this regard, a photoreceptor belt can be used instead of the photoreceptor drum 1.

The optics system includes an fθ lens, a reflecting mirror, a toroidal lens, etc. For example, an optics system disclosed in a US application US20080204846 incorporated herein by reference can be used.

The photo-detector 13 is provided outside of the scanning area (i.e., scan surface) of the photoreceptor drum 1. The light beam deflected by the light deflector 12 enters the photodetector 13 and then moves in a main scanning direction A. For example, as illustrated in FIG. 2, the photodetector 13 includes a photoreceiver including a first photoreceiver 13a having two opposed sides which are perpendicular to the main scanning direction A and through which the light beam passes, and a second photoreceiver 13b having two opposed sides which are slanted relative to the main scanning direction A.

In addition, the photodetector 13 includes an amplifier 13c to amplify a signal (photoelectric conversion signal), which is output by the photoreceiver in proportion to the quantity of light entering the photoreceiver, and a comparator 13d to compare the level of the signal output by the amplifier 13c with a reference level Vr, which is predetermined, and to output the comparison results. In this regard, for example, inversion and amplification of the input signal are performed in the amplifier 13c. In such a case, when the quantity of light entering the photoreceiver increases, the level of the signal output by the amplifier 13c decreases.

The photodetector 13 is used for determining whether to start performing the main scanning operation on the photoreceptor 1 using a light beam and for determining the amount of misalignment of a light beam in the sub-scanning direction.

Driving motors and driving circuits for use in driving the photoreceptor 1 and the light deflector 12 are provided but are not illustrated in FIG. 1. In addition, the detailed structures of the light source 11 and the photodetector 13 are not illustrated in this application, but for example, a light source and a photodetector illustrated in the US application US20080204846 incorporated herein by reference can be used therefor.

Specific examples of the controller 14 include microcomputers including a central processing unit (CPU), a read only memory (ROM) and a random access memory (RAM). The controller 14 controls ON/OFF of the light source 11 according to image data generated and sent from another controller (not shown) while controlling optical writing to be performed on the photoreceptor 1 based on the detection signals output from the photodetector 13. In addition, the controller 14 performs counting for the scanning period, which is the period of the optical scanning of the light deflector 12 in the main scanning direction A, using a RAM. Thus, the controller 14 serves as the first, second and third controllers, a misalignment detector, a writing position correcting member, and a scanning period counter.

The image forming process of the image forming apparatus using the optical scanning device 10 will be described.

The light beam emitted by the light source 11 is collimated by a collimator lens (not shown). The collimated light beam is then deflected by the rotated deflecting member 12. The deflected light beam is focused on a scan surface of the photoreceptor 1, which is previously charged by the charger 2, using an optics system (not shown), thereby forming an electrostatic latent image thereon. Specifically, the light beam is modulated (i.e., turned on and off) by the controller 14 according to the image data while periodically deflected by the light deflector 12. Since the optical scanning operation of the optical scanning device 10 in the main scanning direction is repeatedly performed on the scan surface of the photoreceptor 1 while the photoreceptor is rotated in the sub-scanning direction B, optical image writing is performed on the scan surface of the photoreceptor, resulting in formation of an electrostatic latent image thereon.

The electrostatic latent image thus formed on the scan surface of the photoreceptor 1 is developed by a developing device (not shown) using a charged toner, resulting in formation of a toner image on the surface of the photoreceptor. The toner image is transferred by a transferring device onto a recording material, which is charged by the transferring device so as to have a charge having a polarity opposite to that of the charged toner. After the recording material is separated from the photoreceptor 1, the recording material bearing the toner image thereon is fed to a fixing device so that the toner is fixed on the recording material upon application of heat and pressure. Thus, a visible image is formed on the recording material.

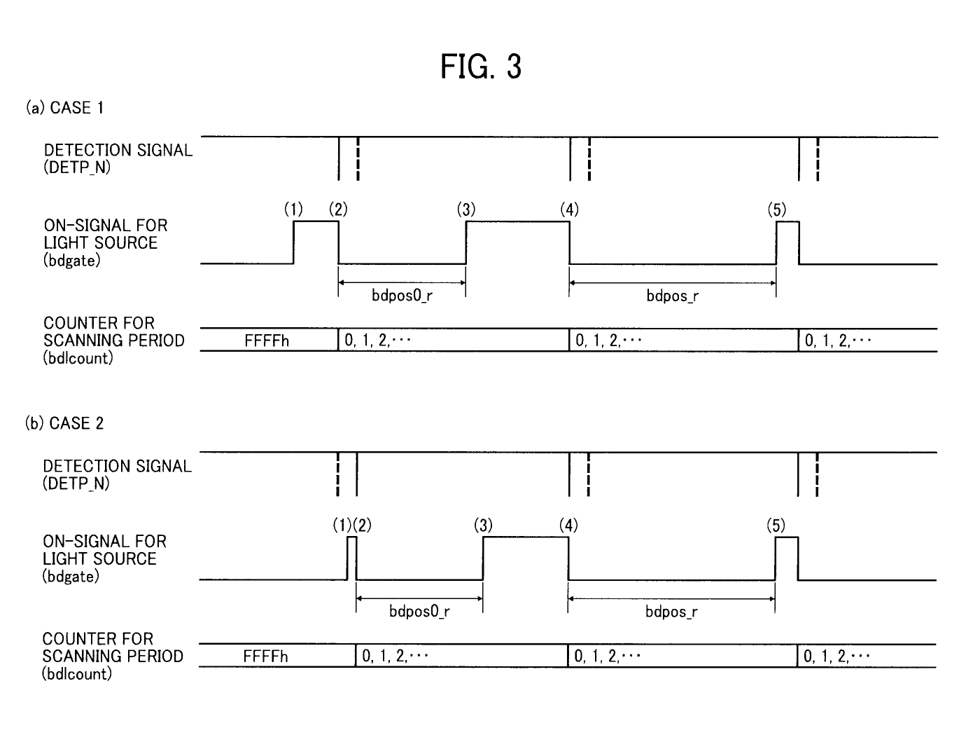

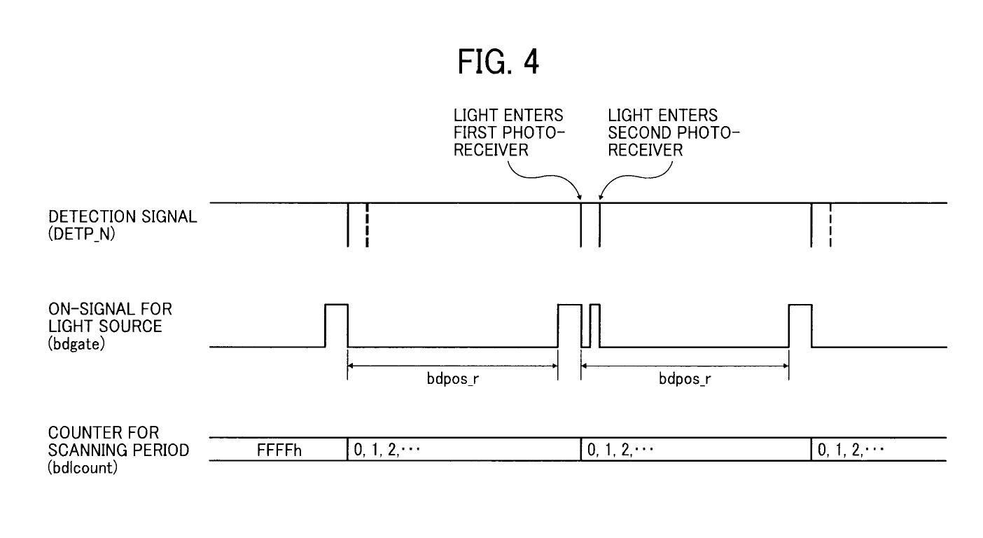

Next, the operations of the controller, i.e., an operation of outputting a detection signal from the photodetector 13, an operation of outputting an ON signal to the light source 11, and a scanning period counting operation will be described by reference to FIGS. 3 and 4.

FIGS. 3(a) and 3(b) are timing charts illustrating two cases of the operations of the controller of the optical scanning device illustrated in FIG. 1. FIG. 4 is a timing chart illustrating another case of the operations of the controller of the optical scanning device illustrated in FIG. 1.

In a case 1 illustrated in FIG. 3(a), a first detection signal is output from the photodetector 13 at a time when a light beam enters the first photoreceiver 13a. In a case 2 illustrated in FIG. 3(b), a first detection signal is output from the photodetector 13 at a time when a light beam enters the second photoreceiver 13b. In FIGS. 3(a) and 3(b), broken lines represent that a detection signal (DETP_N) is not output from the photodetector 13 at those times when a light beam enters any one of the first and second photoreceivers because the light source 11 is in an Off state.

In each of the cases 1 and 2 illustrated in FIGS. 3(a) and 3(b), at times (1)-(5) the controller 14 changes an ON-signal for light source (bdgate) (hereinafter referred to as a light source ON-signal), which is to be output to the light source 11, to a high (H) level or a low (L) level to turn on or off the light source and to start counting for the scanning period (bdlcount).

Specifically, the times (1)-(5) are the following.
(1) When the scanning speed of the light deflector 12 is stabilized, the light source ON-signal (bdgate) is changed to a high (H) level (i.e., the light source 11 is turned on). In this regard, whether or not the scanning speed of the light deflector 12 is stabilized can be determined from the revolution of the driving motor for driving the light deflector 12. Specifically, in a case where the driving motor is a stepping motor, the output signal to the motor is watched, and in a case where the driving motor is a servo motor, the output signal from the encoder provided on the shaft of the motor is watched. When the revolution of the motor, which corresponds to the output signal, reaches a predetermined revolution, it is judged that the scanning speed of the light deflector 12 is stabilized.
(2) When the detection signal (DETP_N) is detected, the level of the light source ON-signal (bdgate) is changed to the low (L) level (i.e., the light source 11 is turned off) while the scanning period counting is started from 0.
(3) When the scanning period count value (bdlcount) becomes a predetermined first value (bdpos0_{—}r) stored in a first register (not shown) or greater (i.e., when a relationship bdlcount≧bdpos0_{—}r is satisfied), the level of the light source ON-signal (bdgate) is changed to the high (H) level (i.e., the light source 11 is turned on).
(4) When the detection signal (DETP_N) is detected, the level of the light source ON-signal (bdgate) is changed again to the low (L) level (i.e., the light source 11 is turned off) while the scanning period counting is started from 0.
(5) When the scanning period count value (bdlcount) becomes a predetermined second value (bdpos_r), which is stored in a second register (not shown) and which is different from the predetermined first value (bdpos0_{—}r), or greater (i.e., when a relationship bdlcount≧bdpos_r is satisfied), the level of the light source ON-signal (bdgate) is changed again to the high (H) level (i.e., the light source 11 is turned on).

Thereafter, by repeating the above-mentioned operational sequences (4) and (5), a detection signal generated when a light beam enters the first photoreceiver 13a can be secured.

In the cases illustrated in FIGS. 3(a) and 3(b), the predetermined first value (bdpos0_{—}r) stored in the first register is about half the scanning period (i.e., a time shorter than the scanning period and longer than a time needed for scanning between the first photoreceiver and the second photoreceiver), and the predetermined second value (bdpos_r) stored in the second register is about 95% of the scanning period. These predetermined first and second values are properly determined depending on the interval between the first and second photoreceivers 13a and 13b. In this regard, it is preferable that the predetermined second value is set to a value slightly shorter than the scanning period, and the predetermined first value is set to a value shorter than the interval between detection of a detection signal when a light beam enters the second photoreceiver 13b and detection of a detection signal when a light beam enters the first photoreceiver 13a in the next scanning.

In addition, when the interval between a time when a light beam enters the first photoreceiver and a time the light beam enters the second photoreceiver is determined to detect the position of the light beam in the sub-scanning direction in the operational sequence (4) or the following sequence according to an instruction from an external device (such as controllers), which is issued, for example, every production of a predetermined number of images, such a method as illustrated in FIG. 4 can be used. Specifically, referring to FIG. 4, when the count (bdlcount) of the counting starting at the time when the light beam enters the first photoreceiver 13a reaches a predetermined third value, which is shorter than the interval between the time when the light beam enters the first photoreceiver 13a and the time when the light beam enters the second photoreceiver 13b, the light source 11 is turned on, and when the light beam then enters the second photoreceiver 13b and thereby a detection signal is detected, the light source 11 is turned off. By using this method, the interval between the time when the light beam enters the first photoreceiver 13a and the time when the light beam enters the second photoreceiver 13b can be determined, thereby determining the position of the light beam in the sub-scanning direction.

In this regard, the first photoreceiver 13a is set so as to be perpendicular to the main scanning direction, and the second photoreceiver 13b is set so as to be slanted relative to the main scanning direction. Therefore, the interval between the light beam entering point of the first photoreceiver 13a and the light beam entering point of the second photoreceiver 13b changes depending on the position of the light beam in the sub-scanning direction. Therefore, the position of a light beam in the sub-scanning direction can be determined depending on the interval between the two adjacent detection signals. Since the interval can be determined from the count value of the scanning period counting, the amount of misalignment of the light beam in the sub-scanning direction can be determined. When the misalignment is greater than a predetermined value, the scanning position is shifted (i.e., the optical image writing timing is changed) in an amount equal to the difference to correct the optical image writing position in the sub-scanning direction.

Thus, the optical scanning device performs the following three control processes (i.e., the device has three controllers):
(1) A first control process (first controller) in which when the scanning speed of the light deflector of the scanner is stabilized, the light source is turned on, and when a detection signal from the photodetector is detected, the light source is turned off while starting counting of the scanning period, which is a period of optical scanning of the scanner in the main scanning direction, from zero;
(2) A second control process (second controller) in which when the count in the scanning period counting performed in the first control process reaches a predetermined first value, the light source is turned on, and when a detection signal is detected, the light source is turned off while starting counting of the scanning period of the scanner in the main scanning direction from zero; and
(3) A third control process (third controller) in which when the count in the scanning period counting performed in the second control process reaches a predetermined second value, the light source is turned on, and when a detection signal is detected, the light source is turned off while starting counting of the scanning period of the scanner in the main scanning direction from zero. This third control process is repeated.

Therefore, even when the timing of turning on the light source is not synchronized with the position of the light deflector in the main scanning direction in start of a scanning operation, a detection signal generated when a light beam enters the first photoreceiver can be secured and used as a reference signal for the main scanning of the light deflector. Therefore, misalignment of the optical scanning line (light beam) in the sub-scanning direction can be prevented.

The controller 14 illustrated in FIG. 1 serves as the first, second and third controllers.

In this regard, by setting the predetermined second value to a time slightly shorter than the scanning period, and by setting the predetermined first value to a time shorter than the interval between detection of a detection signal when a light beam enters the second photoreceiver 13b and detection of a detection signal when a light beam enters the first photoreceiver 13a in the next scanning, the detection signal generated at the time when the light beam enters the first photoreceiver can be secured.

In addition, in the third controlling process, the following control may be performed according to an external instruction. Specifically, after the scanning period counting is started from zero, the light source is turned on before a time when the light beam enters the second photoreceiver, and the position (misalignment) of the light beam in the sub-scanning direction is detected based on the scanning period count value corresponding to the interval between the time when the light beam enters the first photoreceiver and thereby a detection signal is output, and the time when the light beam enters the second photoreceiver and thereby a photo detection signal is output, followed by correction of position of the scanning line (light beam) in the sub-scanning direction based on the detection results, resulting in prevention of misalignment of scanning lines in the optical image writing in the sub-scanning direction.

The third controller (i.e., the controller) also serves as a misalignment detecting member and a writing position correcting member.

The image forming apparatus of the present invention includes the above-mentioned optical scanning device. In the image forming apparatus, the image writing operation is controlled using the main scanning reference signal, and therefore misalignment of scanning lines of the optical image writing in the sub-scanning direction can be prevented. In addition, by changing the optical image writing timing in the sub-scanning direction if necessary, the image writing position in the sub-scanning direction can be corrected, thereby forming high quality images.

The image forming apparatus of this example is a direct transfer type image forming apparatus in which a monochrome toner image is directly transferred from a photoreceptor to a recording material, but the image forming apparatus may be a direct transfer type color image forming apparatus in which two or more color toner images on one or more photoreceptors are directly transferred onto a recording material, or an indirect transfer type color image forming apparatus in which two or more color toner images on one or more photoreceptors are transferred onto an intermediate transfer medium having a belt form or a drum form to form a combined color toner image thereon and the combined color toner image is then transferred onto a recording material. Namely, the optical scanning device of the present invention can be used as an image writing device (i.e., an irradiating device) of such image forming apparatuses.

The program of the present invention is a computer program product, which is stored on a computer readable storage medium and which allows the computer (CPU) of the image forming apparatus (having the optical scanning device) of the present invention to carry out the functions of the first, second and third controllers, the misalignment detecting member and the misalignment correction member. By executing the program using the CPU, the above-mentioned effects can be produced.

The program is stored in a storage device of the optical scanning device or the image forming apparatus, such as ROMs, nonvolatile memories (e.g., flash ROMs and EEPROMs), and hard disk drives (HDDs). Alternatively, the program is stored in a nonvolatile recording medium such as CD-ROMs, memory cards, flexible disks, MOs, CD-Rs, CD-RWs, DVD+Rs, DVD+RWs, DVD-Rs, DVD-RWs, and DVD-RAMs, and the program in the recording medium is installed into the optical scanning device or the image forming apparatus to allow the CPU therein to execute the program, or the CPU reads the program out of the recording medium to execute the program.

In addition, it is possible that the image forming apparatus is connected with a network to download the program, which is stored in an external device storing the program, thereinto to execute the program.

The present invention can be used for optical scanning devices and electrophotographic monochrome or color image forming apparatuses using such optical scanning devices, such as copiers, printers, facsimiles and digital multi-function products (MFPs). Particularly, the present invention is preferably used for an optical scanning device to scan a photoreceptor with a light beam such as laser beams, and image forming apparatuses using such an optical scanning device.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2010-112863, filed on May 17, 2010, the entire contents of which are herein incorporated by reference.

What is claimed is:

1. An optical scanning device comprising:
a light source to emit a light beam;
a scanner to deflect the light beam with a light deflector and to periodically scan, in a main scanning direction, a scan surface of an object moving in a sub-scanning direction with the deflected light beam;
a photodetector which receives the scanned light beam at a position outside the scan surface of the object and outputs a detection signal and which includes a first photoreceiver having two opposed sides through which the light beam passes and which are perpendicular to the main scanning direction and a second photoreceiver having two opposed sides through which the light beam passes and which are slanted relative to the main scanning direction, wherein the detection signal output from the photodetector is used as a reference signal for the scanning of the scanner in the main scanning direction;
a controller to perform a first control operation in which when a scanning speed of the scanner is stabilized, the light source is turned on, and when a detection signal from the photodetector is detected, the light source is turned off while starting counting of a scanning period of the scanner in the main scanning direction from zero; a second control operation in which when the count in the scanning period counting performed in the first control operation reaches a predetermined first value, the light source is turned on, and when a detection signal from the photodetector is detected, the light source is turned off while starting counting of the scanning period of the scanner in the main scanning direction from zero; and a third control operation in which when the count in the scanning period counting performed in the second control operation reaches a predetermined second value, the light source is turned on, and when a detection signal from the photodetector is detected, the light source is turned off while starting counting of the scanning period of the scanner in the main scanning direction from zero, wherein the controller repeats the third control operation until scanning of the object is completed.

2. The optical scanning device according to claim 1, wherein the predetermined second value is a time shorter than the scanning period and longer than a time needed for scanning between the first photoreceiver and the second photoreceiver, and the predetermined first value is a time shorter than an interval between detection of a detection signal generated when a light beam enters the second photoreceiver and detection of a detection signal generated when a light beam enters the first photoreceiver in the next scanning of the scanner.

3. The optical scanning device according to claim 2, wherein in the third control operation, after turning off the light source and starting counting of the scanning period from zero, the controller turns on the light source when the count reaches a predetermined third time shorter than the time needed for scanning between the first photoreceiver and the second photoreceiver, and wherein the controller detects position of the light beam in the sub-scanning direction based on the count in the scanning period counting obtained from a time when the light beam enters the first photoreceiver and thereby a detection signal is generated by the photodetector to a time when the light beam enters the second photoreceiver and thereby a detection signal is generated by the photodetector, and corrects the position of the light beam in the sub-scanning direction based on the position of the light beam.

4. An image forming apparatus comprising:
an image bearing member to bear an electrostatic latent image;
a charger to charge a surface of the image bearing member; and
the optical scanning device according to claim 1 to scan the charged surface of the image bearing member with a light beam emitted by the light source while turning the light source on and off based on image data to form the electrostatic latent image on the surface of the image bearing member.

5. A method for controlling an optical scanning device including a light source to emit a light beam; a scanner to deflect the light beam with a deflector and to periodically scan, in a main scanning direction, a scan surface of an object moving in a sub-scanning direction with the deflected light beam; and a photodetector which receives the scanned light beam at a position outside the scan surface of the object and outputs a detection signal and which includes a first photoreceiver having two opposed sides through which the light beam passes and which are perpendicular to the main scanning direction of the light beam and a second photoreceiver having two opposed sides through which the light beam passes and which are slanted relative to the main scanning direction, wherein the detection signal output from the photodetector is used as a reference signal for the scanning of the scanner in the main scanning direction, the method comprising :
performing a first control step including:
turning on the light source when scanning speed of the scanner is stabilized; and
then turning off the light source while starting counting of the scanning period of the scanner in the main scanning direction from zero when a detection signal from the photodetector is detected;
performing a second control step including:
turning on the light source when count in the scanning period counting in the first control step reaches a predetermined first value; and
then turning off the light source while starting counting of the scanning period of the scanner in the main scanning direction from zero when a detection signal from the photodetector is detected; and
performing a third control step including;
turning on the light source when the count in the scanning period counting in the second control step reaches a predetermined second value;
then turning off the light source while starting counting of the scanning period of the scanner in the main scanning direction from zero when a detection signal is detected; and
then repeating the light source turning-on step and the light source turning-off step in the third control step until scanning of the object is completed.

6. A computer program product stored on a computer readable storage medium for executing the method according to claim 5.

7. An optical scanning device comprising:
lighting means for emitting a light beam;
scanning means for deflecting the light beam and periodically scanning, in a main scanning direction, a scan surface of an object moving in a sub-scanning direction with the deflected light beam;
detecting means which receives the scanned light beam at a position outside the scan surface of the object and outputs a detection signal and which includes a first photoreceiver having two opposed sides through which the light beam passes and which are perpendicular to the main scanning direction and a second photoreceiver having two opposed sides through which the light beam passes and which are slanted relative to the main scanning direction, wherein the detection signal output from the detecting means is used as a reference signal for the scanning of the scanning means in the main scanning direction; and
controlling means for performing a first control operation in which when a scanning speed of the scanning means is stabilized, the lighting means is turned on, and when a detection signal from the detecting means is detected, the lighting means is turned off while starting counting of a scanning period of the scanning means in the main scanning direction from zero; a second control operation in which when the count in the scanning period counting performed in the first control operation reaches a predetermined first value, the lighting means is turned on, and when a detection signal from the detecting means is detected, the lighting means is turned off while starting counting of the scanning period of the scanning means in the main scanning direction from zero; and a third control operation in which when the count in the scanning period counting performed in the second control operation reaches a predetermined second value, the lighting means is turned on, and when a detection signal from the detecting means is detected, the lighting means is turned off while starting counting of the scanning period of the scanning means in the main scanning direction from zero, wherein the controlling means repeats the third control operation until scanning of the object is completed.
